(19) United States
(12) Patent Application Publication
(10) Pub. No.: US 2008/0266661 A1
(43) Pub. Date: Oct. 30, 2008

(54) Polarizing Plate

(75) Inventor: Norinaga Nakamura, Okayama-Ken (JP)

Correspondence Address: BURR & BROWN, PO BOX 7068, SYRACUSE, NY, 13261-7068, US

(73) Assignee: DAI NIPPON PRINTING CO., LTD, SHINJUKU-KU TOKYO-TO (JP)

(21) Appl. No.: 11/817,823

(22) PCT Filed: Mar. 29, 2006
(86) PCT No.: PCT/JP2006/306513

§ 371 Date: Apr. 22, 2008

(30) Foreign Application Priority Data
Mar. 30, 2005 (JP) 2005-099009

(51) Int. Cl. G02B 5/30; G02F 1/1335

(52) U.S. Cl. 359/485; 349/96

(57) ABSTRACT

A polarizing plate having a first light transparent base material, and a polarizer and an optical laminate provided in that order on the first light transparent base material The first light transparent base material is a nonstretched base material, the optical laminate includes a second light transparent base material which is a stretched base material, and the optical laminate includes one or at least two optical property layers provided on the second light transparent base material The interface of the second light transparent base material and the optical property layer has been rendered absent by bringing the second light transparent base material and the optical property layer into contact with each other through an interface preventive adhesive layer.

### CROSS-REFERENCE TO RELATED APPLICATIONS

This application is based upon and claims the benefit of priority from the prior Japanese Patent Applications No. 99009/2005 under the Paris Convention, and, thus, the entire contents thereof are incorporated herein by reference.

### BACKGROUND OF THE INVENTION

1. Technical Field

The present invention relates to a polarizing plate and an image display member using the polarizing plate.

2. Background Art

A polarizing plate, which can convert uniform light to a linearly polarized light in a given direction, is used in image display devices such as liquid crystal display devices (LCDs) and electroluminescent display devices (ELs). The polarizing plate plays an important role in optical display qualities such as contrast, lightness, chroma and hue. In the polarizing plate, in general, a polarizer is held between two light transparent base materials. In particular, the light transparent base material in the polarizing plate on its viewer side is used as a base material in the optical (antireflection) laminate, and the formation of an optical property layer such as a hard coat layer thereon can develop desired optical properties.

For example, polyvinyl alcohol (PVA) is known as a polarizer usable in the polarizing plate. PVA, however, suffers from a problem of moisture absorption and, further, in use on the outermost surface of the display, poses a problem of strength. Accordingly, excellent strength and water resistance are required of the light transparent base material for holding the polarizer. Further, flatness is necessary from the viewpoint of appearance of a display screen. Accordingly, it is common practice to use, as the light transparent base material for polarizing plate formation, inorganic materials such as glass, or polymer base materials (nonstretched base materials, for example, triacetate cellulose) (Japanese Patent Laid-Open No. 61626/1997).

On the other hand, the nonstretched base material, particularly triacetate cellulose (TAC), is more expensive than the stretched base material. Accordingly, if inexpensive base materials could be used instead of the expensive material, then the cost could be reduced and a large quantity of inexpensive polarizing plates could be supplied. Further, the triacetate cellulose base material is flexible but has recesses and the like on its surface and thus is not flat. Thus, the material somewhat deteriorates the appearance of the display screen. In particular, when the outermost surface has been subjected to concavoconvex-free clear hard coat treatment, for example, a deformed fluorescent lamp image reflected from the surface is sometimes observed. Accordingly, an optical properly layer is formed for realizing an ideal display screen, pretreatment is necessary. Further, it has often been pointed out that, when triacetate cellulose is utilized as a light transparent base material, the material is poor, for example, in durability and heat resistance in electron beam curing, heat curing and other treatments used in forming an optical property layer on the light transparent base material.

In the optical laminate comprising layers, which are significantly different from each other in refractive index, stacked on top of each other, however, interface reflection and interference fringes often occur in the interface between the mutually superimposed layers. In particular, it has been pointed out that interference fringes are significant in the reproduction of a black color on the image display surface of an image display device and, consequently, the visibility of the image is lowered and, at the same time, the appearance of the image on the image display surface is deteriorated. In this connection, it is particularly said that, when the refractive index of the light transparent base material is different from the refractive index of the hard coat layer, interference fringes are highly likely to occur.

On the other hand, Japanese Patent Laid-Open No. 75605/2003 proposes the use of an antireflection hard coat sheet comprising a transparent base material film and a medium-refractive index layer having a refractive index of 1.5 to 1.7, a higher-refractive index layer having a refractive index of 1.6 to 1.8, and a lower-refractive index layer formed of a material having a lower refractive index than the higher-refractive index layer provided in that order on the transparent base material film. The claimed advantage of the antireflection hard coat sheet is to realize the elimination of interface reflection, interference fringes and the like.

So far as the present inventors know, however, any polarizing plate having the following construction has not hitherto been proposed: in a polarizing plate, one of two light transparent base materials is a stretched base material (on viewer side) and the other light transparent base material is a nonstretched base material, and an optical property layer (for example, a hard coat layer) is provided on the stretched base material (on viewer side) to realize strength (hardness) and surface flatness high enough to be usable on the outermost surface of the display, and, further, in forming an optical property layer (for example, a hard coat layer) on the stretched base material (on viewer side), the interposition of the interface preventive adhesive layer can render the interface (an interface from an optical aspect: an interface which does not cause interference fringes) of the stretched base material and the optical property layer substantially absent, whereby the occurrence of the interface reflection and interference fringes could have been effectively prevented.

Accordingly, at the present time, the development of a polarizing plate, which has excellent strength (hardness), surface flatness, and water resistance, can effectively prevent interface reflection and interference fringes, and has excellent antireflection properties, has been urgently desired.

### DISCLOSURE OF INVENTION

At the time of the present invention, the present inventors have found that a polarizing plate, which is improved in hardness, flatness, and moisture resistance and, at the same time, can effectively prevent interface reflection and interference fringes and can develop desired optical properties, can be provided by using specific polymer base materials in two optical light transparent base materials constituting the polarizing plate. Accordingly, the present invention provides a polarizing plate which can develop excellent optical properties and physical strength by adopting a stretched polymer base material and a nonstretched polymer base material as the light transparent base material for holding the polarizer and bringing the light transparent base material and the optical property layer constituting the optical laminate into intimate contact with each other through an interface preventive adhesive layer.

The above object can be attained by a polarizing plate comprising: a first light transparent base material; and a polarizer and an optical laminate provided in that order on the first light transparent base material, wherein

the first light transparent base material is a nonstretched base material,

the optical laminate comprises a second light transparent base material which is a stretched base material,

the optical laminate comprises one or at least two optical property layers provided on the second light transparent base material, and

the interface (an interface from an optical aspect) of the second light transparent base material and the optical property layer has been rendered absent by providing the optical property layer on the second light transparent base material through an interface preventive adhesive layer.

In another aspect of the present invention, there is provided an image display member comprising a display element disposed between the first and second polarizing plates, wherein

the first polarizing plate comprises a first light transparent base material, and a polarizer and an optical laminate provided in that order on the first light transparent base material,

the first light transparent base material is a nonstretched base material,

the optical laminate comprises a second light transparent base material which is a stretched base material,

the optical laminate comprises one or at least two optical property layers provided on the second light transparent base material,

the interface (interface from optical aspect) of the second light transparent base material and the optical property layer has been rendered absent by providing the optical property layer on the second light transparent base material through an interface preventive adhesive layer,

the first polarizing plate is located on a viewer side, and

the second polarizing plate comprises two light transparent base materials and a polarizer held between the light transparent base materials.

The polarizing plate and image display member according to the present invention are advantageous in that, by virtue of the use of a stretched base material as a light transparent base material on the viewer side (optical laminate side), the hardness, flatness and moisture resistance after the surface treatment are excellent and the manufacture of the polarizing plate and image display member is easy. Further, in the polarizing plate according to the present invention, by virtue of the formation of an optical property layer on the light transparent base material (stretched base material) constituting the optical laminate through the interface preventive adhesive layer, the interface can be rendered absent, the occurrence of the interface reflection and interference fringes can be effectively prevented, and the formation of a high-quality image can be realized.

### BRIEF DESCRIPTION OF THE DRAWINGS

FIG. 1 is a schematic view of a polarizing plate according to the present invention.

FIG. 2 is a schematic view of an image display member according to the present invention.

### BEST MODE FOR CARRYING OUT THE INVENTION

### Embodiments of the Present Invention

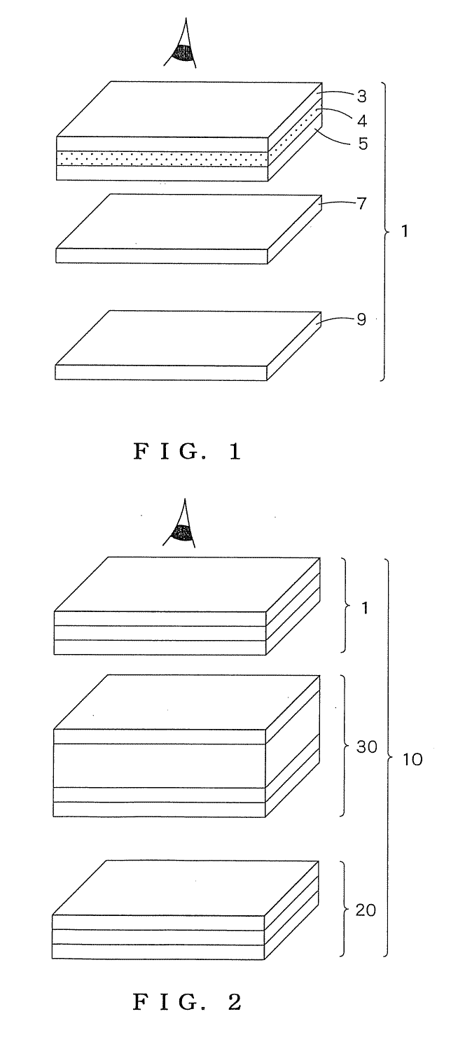

The polarizing plate according to the present invention will be described with reference to FIG. 1. FIG. 1 is a schematic view of a polarizing plate 1 according to the present invention. In FIG. 1, a polarizer 7 is held between a second light transparent base material 5 (a stretched base material) on a viewer side and a first light transparent base material 9 (a nonstretched base material). In the present invention, the second light transparent base material 5 functions as a base material in the optical laminate. One or at least two optical property layers 3 are provided on the second light transparent base material 5 through an interface preventive adhesive layer 4.

The image display member according to the present invention will be described with reference to FIG. 2. FIG. 2 is a schematic view of an image display member 10 according to the present invention. The image display member according to the present invention comprises a (first) polarizing plate 1 according to the present invention, a display element 30, and a (second) polarizing plate 20. In a preferred embodiment of the present invention, one of the light transparent base materials in the second polarizing plate is a nonstretched base material, and the other light transparent base material in the second polarizing plate is a nonstretched base material or a stretched base material.

1. Polarizing Plate

1) Light Transparent Base Material

The polarizing plate comprises two light transparent base materials for holding a polarizer therebetween. In the present invention, the first light transparent base material is a nonstretched base material, and preferred examples thereof include triacetate cellulose. On the other hand, the second light transparent base material constituting the optical laminate is a stretched base material. The stretched base material as the second light transparent base material is preferably a monoaxially stretched base material or a biaxially stretched base material. Polyethylene terephthalate may be mentioned as a specific example of preferred stretched base material.

The thickness of the first light transparent base material and the thickness of the second light transparent base material may be the same or different. Specifically, the thickness is not less than 20 μm and not more than 500 μm. Preferably, the lower limit of the thickness is 40 μm, and the upper limit of the thickness is 250 μm.

2) Polarizer

The polarizer according to the present invention may be a polyvinyl alcohol film per se or a modified product thereof. The polarizer may be produced by dying a polyvinyl alcohol film with iodine and monoaxially stretching the dyed film, or by immersing polyvinyl alcohol in an aqueous solution of iodine for dying of the polyvinyl alcohol, and stretching the polyvinyl alcohol by a factor of 3 to 7 of the original length. In a preferred embodiment of the present invention, if necessary, immersion in an aqueous solution of boric acid, potassium iodide or the like may be carried out. If necessary, before dying of the polyvinyl alcohol film with iodine, the polyvinyl alcohol film may be immersed in water for water washing. Contaminants can be removed by water washing, and swelling of the polyvinyl alcohol film can effectively prevent uneven dying. Stretching may be carried out before, after or during dying with iodine. The stretching may be carried out in an aqueous solution of boric acid or potassium iodide or in a water bath.

In a preferred embodiment of the present invention, the polarizer may contain at least one metal element, preferably at least one element selected from the group consisting of Zn (zinc), Cu (copper), B (boron), Al (aluminum), Ti (titanium), Zr (zirconium), Sn (tin), V (vanadium) and Cr (chromium). The metal component and the like may be incorporated by a conventional method. The thickness of the polarizer is generally not less than 5 μm and not more than 80 μm.

Adhesive Layer (Agent)

In the present invention, when a polarizer is interposed between a first light transparent base material and a second light transparent base material, the interposition may be carried out with the aid of an adhesive layer (agent). In the present invention, preferably, an optically isotropic adhesive layer (agent) is generally used for intimate contact among the nonstretched base material as the first light transparent base material, the polarizer, and the stretched base material as the second light transparent base material. Intimate contacting methods include wet lamination in which, after the application of the materials with the aid of an adhesive layer (agent), the assembly is dried to remove the solvent, and dry lamination in which an adhesive layer (agent) is applied to the materials and the materials are dried and are applied to each other.

Such adhesive layers (agents) include, for example, polyvinyl alcohol-type adhesives, urethane-type adhesives, epoxy-type adhesives and acryl-type adhesives. In the present invention, in addition to the above adhesives, pressure-sensitive adhesives or tackiness agents (tacky adhesives) are usable. Specific examples of pressure-sensitive adhesives or tackiness agents include acrylic acid-type, methacrylic acid-type, butyl rubber-type, and silicone-type base polymers. More specifically, suitable pressure-sensitive adhesives or tackiness agents include (meth)acrylic acid-type base polymers such as butyl (meth)acrylate, ethyl(meth)acrylate, isooctyl(meth)acrylate, 2-ethylhexyl(meth)acrylate, and copolymer-type base polymers using two or more of these (meth)acrylic esters. Tackiness agents may be generally produced as these base polymers in which a polar monomer has been copolymerized. Specific examples of polar monomers to be copolymerized include monomers containing carboxyl, hydroxyl, amide, amino, and epoxy groups, for example, (meth)acrylic acid, 2-hydroxyethyl (meth)acrylate, 2-hydroxypropyl(meth)acrylate, (meth)acrylamide, N,N-dimethylaminoethyl(meth)acrylate, and glycidyl(meth)acrylate. Crosslinking agents include those which, together with a divalent or polyvalent metal ion, produces a carboxylic acid metal salt, and those which, together with polyisocyanate compounds, form an amide bond. One or at least two of these compounds are mixed in the base polymer.

In a preferred embodiment of the present invention, when the tackiness layer (agent) is used, the surface of the first light transparent base material and/or the surface of the second light transparent base material may be subjected to pretreatment such as corona treatment. The thickness of the tackiness layer (agent) is approximately not less than 0.1 μm and not more than 50 μm.

3) Interface Preventive Adhesive Layer

In the present invention, the interface of the second light transparent base material and the optical property layer has been rendered absent by bringing the second light transparent base material and the optical property layer into contact with each other through an interface preventive adhesive layer. In the present invention, the expression “interface is (substantially) absent” means that, in fact, there is no optical interface although two layer faces are superimposed on top of each other, and further connotes that, based on the refractive index value, the interface is judged to be absent between both the layer faces. A specific example of a criterion based on which the “interface is (substantially) absent” is that, for example, in visual inspection, any interference fringe is not found under observation with light for interference fringe observation (a three-wavelength fluorescent lamp). Further, in the observation of the cross-section of the optical laminate under a laser microscope, when interference fringes are visually observed, the interface is regarded as present in the cross section of the laminate, while, when any interference fringe is not visually observed, the interface is regarded as absent in the cross section of the laminate. The laser microscope can observe the cross section of materials different in refractive index in a nondestructive manner. Accordingly, in the case of materials having no significant difference in refractive index therebetween, the results of the measurement show that there is no interface between these materials. Therefore, it can also be judged based on the refractive index that there is no interface between the light transparent base material and the optical property layer (for example, hard coat layer).

The interface preventive adhesive layer is formed using a composition comprising a resin and a dispersion liquid. The mixing ratio between the resin and the dispersion liquid may be properly determined but is generally not less than about 75:25 and not more than about 92:8. Preferably, the lower limit of the mixing ratio is about 80:20, more preferably about 85:15. When the mixing ratio falls within the above-defined range, the increase in refractive index can be effectively suppressed to provide desired refractive index properties. Further, in this case, the adhesion can be advantageously improved. The refractive index of the whole interface preventive adhesive layer is preferably not less than 1.67 and not more than 1.69. The thickness of the interface preventive adhesive layer is preferably not less than 50 nm and not more than 150 nm. When the refractive index and the layer thickness fall within the respective defined ranges, interference fringes can be prevented well in polyethylene terephthalate as a preferred stretched base material and no interference can be realized.

Resin

Preferably, the resin upon drying and curing has a refractive index of not less than 1.50 and not more than 1.53. Specific examples of preferred resins include polyester resins or urethane resins as main resins. Specific examples of polyester resins are those produced by a well-known method from an acid starting material, for example, terephthalic acid, isophtalic acid, phthalic acid, methylphthalic acid, trimellitic acid, pyromellitic acid, adipic acid, sebacic acid, succinic acid, maleic acid, fumaric acid, tetrahydrophthalic acid, methyltetrahydrophthalic acid, hexahydrophthalic acid, and these reactive derivatives, and an alcohol starting material, for example, ethylene glycol, propylene glycol, 1,3-butanediol, 1,4-butanediol, 1,6-hexanediol, diethylene glycol, dipropylene glycol, 1,4-cyclohexanedimethanol, neopentyl glycol, isopentyl glycol, bishydroxyethyl terephthalate, hydrogenated bisphenol A, an alkylene oxide adduct of hydrogenated bisphenol AA, trimethylolethane, trimethylolpropane, glycerin, pentaerythritol, and 2,2,4-trimethylpentane-1,3-diol, and are not particularly limited. Noncrsytalline copolymer polyesters are most preferred as the polyester resin.

Specific examples of preferred urethane resins include moisture curable type (one-component type), heat curable type (two-component type) or other reaction curable type urethane adhesives. Specifically oligomers and prepolymers of polyisocyanate compounds may be used as the moisture curable type urethane adhesive, and mixtures of monomers, oligomers, and prepolymers of polyisocyanate compounds with oligomers and prepolymers of polyol compounds may be used as the heat curable type urethane adhesive. When these reaction curable type urethane adhesives are used, after lamination, the assembly is aged under a temperature in the range of room temperature to 40° C.

Other Components

In a preferred embodiment of the present invention, an isocyanate group-containing compound is added to the composition for an interface preventive adhesive layer. Specific examples of isocyanate group-containing compounds include tolylene diisocyanate (TDI), 3,3′-tolylene-4,4′-isocyanate, diphenylmethane 4,4′-diisocyanate (MDI), triphenylmethane p,p′,p″-triisocyanate (T.M), 2,4-tolylene dimer (TT), naphthalene-1,5-diisocyanate, tris(4-phenylisocyanate)thiophosphate, crude (MDI), TDI trimer, dicyclohexamethane 4,4′-diisocyanate(HMDI), hydrogenated TDI (HTDI), methxylylene diisocyanate(XDI), hexahydromethxylylene diisocyanate(HXDI), hexamethylene diisocyanate, trimethylpropane-1-methyl-2-isocyano-4-carbamate, polymethylene polyphenyl isocyanate, 3,3′-dimethoxy-4,4′-diphenyl diisocyanate, diphenyl ether 2,4,1′-triisocyanate, m-xylylene diisocyanate (MXDI), and polymethylene polyphenyl isocyanate (PAPI). The addition amount of the isocyanate group-containing compound is preferably not less than 10% by weight based on the total amount of the composition for an interface preventive adhesive layer.

Other resins may be added to the composition for an interface preventive adhesive layer used in the present invention. For example, ionizing radiation curing resins may be added. When ionizing radiation curing resins are added, the adhesion and flexibility of the optical laminate (particularly a hard coat layer) stacked on the interface preventive adhesive layer can be advantageously freely regulated.

Among ionizing radiation curing resins, acrylate-type functional group-containing ionizing radiation curing resins are preferred. Specific examples of ionizing radiation curing resins include those containing an acrylate-type functional group, for example, oligomers or prepolymers and reactive diluents, for example, relatively low-molecular weight polyester resins, polyether resins, acrylic resins, epoxy resins, urethane resins, alkyd resins, spiroacetal resins, polybutadiene resins, and polythiol polyene resins and (meth)acrylates of polyfunctional compounds such as polyhydric alcohols. Specific examples thereof include monofunctional monomers such as ethyl(meth)acrylate, ethylhexyl(meth)acrylate, styrene, methyl styrene, and N-vinylpyrrolidone, and polyfunctional monomers, for example, trimethylolpropane tri(meth)acrylate, hexanediol(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

When ionizing radiation curing resins are used as an ultraviolet curing resin, for example, a photopolymerization initiator and a photosensitizer may be mixed in the system. Specific examples of photopolymerization initiators include acetophenones, benzophenones, Michler's benzoyl benzoate, α-amyloxime ester, tetramethyl thiuram monosulfide, and thioxanthones. Specific examples of photosensitizers include n-butylamine, triethylamine, and tri-n-butylphosphine. In the present invention, preferably, urethane acrylate as an oligomer and dipentaerythritol hexaacrylate as a monomer may be mixed.

Dispersion Liquid

The dispersion liquid comprises metal oxide fine particles having a primary particle diameter in the range of 1 to 30 nm, an ionizing radiation curing resin, an anionic polar group-containing dispersing agent, an organic solvent, and a titanate-type or aluminum-type coupling agent. The dispersion liquid is preferably regulated so that the refractive index of a product obtained by drying and curing the dispersion liquid is not less than 1.72 and not more than 1.80.

Metal Oxide Fine Particles

The metal oxide fine particles have a medium to higher refractive index (1.90 to 2.55), are colorless or uncolored, and may have any shape. In the metal oxide fine particles according to the present invention, the primary particle diameter is 1 to 30 nm, preferably 30 nm or less. The primary particle diameter of the metal oxide fine particles may be visually measured, for example, under a scanning electron microscope (SEM) or a transmission electron microscope (TEM), or alternatively may be mechanically measured, for example, with a particle size distribution meter utilizing a dynamic light scattering method or a static light scattering method.

A specific example of metal oxide fine particles is one material or a mixture of two or more materials selected from the group consisting of titanium oxide, zirconium oxide, zinc oxide, tin oxide, cerium oxide, antimony oxide, indium tin mixed oxide and antimony tin mixed oxide. Titanium oxide is preferred. Specific examples of titanium oxide include rutile form of titanium oxide, anatase form of titanium oxide, and amorphous form of titanium oxide. Among them, rutile form of titanium oxide having a high refractive index is preferred.

Ionizing Radiation Curing Resin

A monomer or oligomer containing a functional group, which, upon exposure to an ionizing radiation such as ultraviolet light or electron beams, causes a polymerization reaction directly or indirectly through the action of an initiator may be mentioned as a specific example of the ionizing radiation curing resin. In the present invention, an ethylenical double bond-containing radical polymerizable monomer or oligomer may be mainly used, and, if necessary, a photoinitiator may be used in combination with the monomer or oligomer. Other ionizing radiation curing resins may also be used. For example, photocation polymerizable monomers and oligomers such as epoxy group-containing compounds may be used. The photocation polymerizable resin may if necessary be used in combination with a photocation polymerization initiator. The monomer or oligomer as the resin is preferably a polyfunctional resin containing two or more polymerizable functional groups from the viewpoint of causing a crosslinking bond between molecules of the resin. Accordingly, in the present specification, unless otherwise specified, curable resin precursors such as monomers, oligomers, and prepolymers are defined as “resin.”

Specific examples of ethylenical double bond-containing radical polymerizable monomers and oligomers include monofunctional (meth)acrylates such as 2-hydroxyethyl (meth)acrylate, 2-hydroxypropyl(meth)acrylate, hydroxybutyl acrylate, 2-hydroxy-3-phenoxypropyl acrylate, carboxypolycaptolactone acrylate, acrylic acid, methacrylic acid, and acrylamide; diacrylates such as pentaerythritol triacrylate, ethyleneglycol diacrylate, and pentaerythritol diacrylate monostearate; tri(meth)acrylates such as trimethylolpropane triacrylate and pentaerythritol triacrylate; polyfunctional (meth)acrylates such as pentaerythritol tetraacrylate derivatives or dipentaerythritol pentaacrylate, or oligomers obtained by polymerizing these radical polymerizable monomers. The term “(meth)acrylate” as used herein refers to acrylate and/or methacrylate.

Among ionizing radiation curing resins, resins with a hydroxyl group remaining in the molecule are preferred. Since the hydroxyl group is also an anionic polar group, this resin has a high level of affinity for metal oxide fine particles and functions as a dispersion aid. Accordingly, the use of this resin can improve the dispersibility of the metal oxide fine particles in the dispersion liquid and further has the effect of reducing the amount of the dispersing agent used. The dispersing agent does not function as a resin, and, thus, the strength of the coating film can be improved by reducing the mixing ratio of the dispersing agent.

Specific examples of resins with a hydroxyl group remaining in the molecule include those comprising pentaerythritol polyfunctional (meth)acrylate or dipentaerythritol polyfunctional (meth)acrylate as a skeleton of the binder resin and a hydroxyl group remaining in the molecule. In this resin, two or more molecules of (meth)acrylic acid are ester bonded to one molecule of pentaerythritol or dipentaerythritol. In this case, a part of the hydroxyl group originally present in the molecule of pentaerythritol or dipentaerythritol remains unesterified. For example, pentaerythritol triacrylate may be exemplified. Pentaerythritol polyfunctional acrylate and dipentaerythritol polyfunctional acrylate contain two or more ethylenical double bonds per molecule, and, thus, a crosslinking reaction takes place during polymerization resulting in high coating film strength.

Photoinitiator

Photoinitiators which initiate radical polymerization include, for example, 1-hydroxy-cyclohexyl-phenyl-ketone, 2-methyl-1[4-(methylthio)phenyl]-2-morpholinopropane-1-one, benzyl dimethyl ketone, 1-(4-dodecylphenyl)-2-hydroxy-2-methylpropane-1-one, 2-hydroxy-2-methyl-1-phenylpropane-1-one, 1-(4-isopropylphenyl)-2-hydroxy-2-methylpropane-1-one, and benzophenone. Among them, 1-hydroxy-cyclohexyl-phenyl-ketone and 2-methyl-1 [4-(methylthio)phenyl]-2-morpholinopropane-1-one are preferred in the present invention because the polymerization reaction can be initiated and promoted upon exposure to an ionization radiation even at a low dose. One of or a combination of two or more of these photoinitiators may be used. These photoinitiators may be commercially available products. For example, 1-hydroxy-cyclohexyl-phenyl-ketone is available from CIBA-GEIGY (Japan) Ltd. under the designation Irgacure 184.

Dispersing Agent

The anionic polar group possessed by the dispersing agent has a high level of affinity for metal oxide fine particles, particularly titanium oxide fine particles, and the dispersing agent containing an anionic polar group is incorporated to impart dispersiblity to the metal oxide fine particles. Anionic polar groups include, for example, carboxyl, phosphoric acid, and hydroxyl groups. Specific examples thereof include a group of products commercially available from BYK-Chemie Japan KK under the tradename designation Disperbyk, that is, Disperbyk-111, Disperbyk-110, Disperbyk-116, Disperbyk-140, Disperbyk-161, Disperbyk-162, Disperbyk-163, Disperbyk-164, Disperbyk-170, Disperbyk-171, Disperbyk-174, Disperbyk-180, Disperbyk-182 and the like.

Among them, compounds having a molecular structure comprising a side chain of the above anionic polar group or a side chain containing the anionic polar group bonded to a main chain with a skeleton of an ethylene oxide chain, and having a number average molecular weight of 2,000 to 20,000 are preferred from the viewpoint of realizing particularly good dispersibility. The number average molecular weight may be measured by GPC (gel permeation chromatography). Among the above-described Disperbyk series, Disperbyk-163 may be mentioned as the compound which meets the above requirement.

Organic Solvent

The organic solvent is used for dissolving/dispersing solid matter in the dispersion liquid. For example, alcohols such as isopropyl alcohol, methanol and ethanol; ketones such as methyl ethyl ketone, methyl isobutyl ketone, and cyclohexanone; esters such as ethyl acetate and butyl acetate; halogenated hydrocarbons; aromatic hydrocarbons such as toluene and xylene; or a mixture of two or more of them.

In the present invention, ketone-type organic solvents are preferred. A single solvent of one ketone, a mixed solvent composed of two or more ketones, and a mixed solvent, which is composed of one or at least two ketones and other solvent(s) and does not lose properties as the ketone solvent. Preferably, a ketone-type solvent of which not less than 70% by weight, particularly not less than 80% by weight, is accounted for by one or at least two ketones.

Coupling Agent

Titanate-type or aluminum-type coupling agents has the effect of improving the dispersibility of metal oxide fine particles, lowering the viscosity of the coating composition, improving the processability, increasing the filling ratio of the metal oxide fine particles, and reducing interface voids (reducing aggregated masses).

Titanate-type or aluminum-type coupling agents are classified into carboxyl-type, pyrophosphate-type, phosphite-type and amino-type which are transited in that order from hydrophobic nature to hydrophilic nature.

Specific examples of titanate-type coupling agents include those containing a titanium-containing hydrophilic group, which interacts with metal oxide fine particles, and a hydrophobic group which interacts with the resin or solvent matrix, and examples thereof include a group of titanate-type coupling agents available from Ajinomoto Co., Inc. under the tradename designation PLENACT (KR-TTS, KR-46B, KR-55, KR-41B, KR-38S, KR-138S, KR-238S, 338X, KR-44, and KR9SA). For example, in the case of alkyl titanates, those having a long alkyl chain and capable of forming a stable complex are preferred, and, in the case of polymers, those having a high molecular weight are preferred.

Specific examples of aluminum-type coupling agents include aluminum isopropylate, mono-sec-butoxyaluminum diisopropylate, aluminum sec-butylate, aluminum ethylate, ethyl acetoacetate aluminum diisopropylate, aluminum tris(ethyl acetoacetate), alkyl acetoacetate aluminum diisopropylate, aluminum monoacetyl acetonate bis(ethyl acetoacetate), aluminum tris(acetyl acetonate), aluminum monoisopropoxy monooleoxyethyl acetoacetate, and cyclic aluminum oxide isopropylate.

Other Components

The dispersion liquid may contain, in addition to the above indispensable components, optionally a polymerization initiator for the ionizing radiation curing resin and other components. Examples of such optional other components include ultraviolet shielding agents, ultraviolet absorbers, and surface modifiers (leveling agents).

Method for Preparing Dispersion Liquid

The content of the metal oxide fine particles is preferably 30 to 65% by weight based on the total solid content. The content of the coupling agent is preferably 1 to 15% by weight based on the total solid content, more preferably 3 to 10% by weight. In the dispersion liquid, the content of the organic solvent is preferably 50 to 99.5 parts by weight based on 0.5 to 50 parts by weight of the total solid content. The content of the dispersing agent is preferably 10 to 20% by weight based on the total solid content of the dispersing agent. The content of the resin is preferably 20 to 60% by weight based on the total solid content of the resin.

The dispersion liquid is produced by mixing indispensable components and other components in any desired order, introducing media such as beads to the resultant mixture, and subjecting the mixture to proper dispersion treatment, for example, with a paint shaker or a bead mill to give a coating composition. More specifically, the dispersion liquid may be produced by a method disclosed in Japanese Patent Laid-Open No. 96400/2003. Accordingly, the contents of the specification and drawings disclosed in this laid-open publication constitute the contents of the present specification.

4) Optical Laminate

The optical laminate comprises a second light transparent base material and one or at least two optical property layers (for example, hard coat layer) provided on the second light transparent base material through an interface preventive adhesive layer. One layer or at least two layers selected from the group consisting of a hard coat layer, an antistatic layer, an anti-dazzling layer, a low-refractive index layer, and a contamination preventive layer may be mentioned as the optical property layer.

Hard Coat Layer

In the present invention, the hard coat layer refers to a layer having a hardness of “H” or higher as measured by a pencil hardness test specified in JIS K 5600-5-4 (1999). The thickness (in a cured state) of the hard coat layer is 0.1 to 100 μm, preferably 0.8 to 20 μm. The hard coat layer may comprise a resin and other optional components. Preferably, dimer or higher oligomers or polymers may be added to impart flexibility to the hard coat layer.

Resin

The resin is preferably transparent, and specific examples thereof are classified into ionizing radiation curing resins which are curable upon exposure to ultraviolet light or electron beams, mixtures of ionizing radiation curing resins with solvent drying-type resins (resins which are formed into films by merely removing a solvent, added for regulating the solid content in the coating, by drying, for example, thermoplastic resins), or heat curing resins. Preferred are ionizing radiation curing resins.

Specific examples of ionizing radiation curing resins include those containing an acrylate-type functional group, for example, oligomers or prepolymers and reactive diluents, for example, relatively low-molecular weight polyester resins, polyether resins, acrylic resins, epoxy resins, urethane resins, alkyd resins, spiroacetal resins, polybutadiene resins, and polythiol polyene resins and (meth)acrylates of polyfunctional compounds such as polyhydric alcohols. Specific examples thereof include monofunctional monomers such as ethyl(meth)acrylate, ethylhexyl(meth)acrylate, styrene, methyl styrene, and N-vinylpyrrolidone, and polyfunctional monomers, for example, polymethylolpropane tri(meth)acrylate, hexanediol(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

When ionizing radiation curing resins are used as an ultraviolet curing resin, preferably, a photopolymerization initiator is used. Specific examples of photopolymerization initiators include acetophenones, benzophenones, Michler's benzoyl benzoate, α-amyloxime ester, tetramethyl thiuram monosulfide, and thioxanthones. Preferably, photosensitizers are mixed in the system. Specific examples of photosensitizers include n-butylamine, triethylamine, and poly-n-butylphosphine.

The solvent drying-type resin used as a mixture with the ionizing radiation curing resin is mainly a thermoplastic resin. Commonly exemplified thermoplastic resins are usable. Coating defects of the coated face can be effectively prevented by adding the solvent drying-type resin. Specific examples of preferred thermoplastic resins include styrenic resins, (meth)acrylic resins, vinyl acetate resins, vinyl ether resins, halogen-containing resins, alicyclic olefinic resins, polycarbonate resins, polyester resins, polyamide resins, cellulose derivatives, silicone resins, and rubbers or elastomers. The resin is generally noncrystalline and, at the same time, is soluble in an organic solvent (particularly a common solvent which can dissolve a plurality of polymers and curable compounds). Particularly preferred are resins having good moldability or film forming properties, transparency, and weathering resistance, for example, styrenic resins, (meth)acrylic resins, alicyclic olefinic resins, polyester resins, and cellulose derivatives (for example, cellulose esters). In a preferred embodiment of the present invention, when the transparent base material is formed of a cellulosic resin such as triacetylcellulose “TAC,” specific examples of preferred thermoplastic resins include cellulosic resins, for example, nitrocellulose, acetylcellulose, cellulose acetate propionate, and ethylhydroxyethylcellulose.

Specific examples of heat curing resin include phenolic resins, urea resins, diallyl phthalate resins, melamine resins, guanamine resins, unsaturated polyester resins, polyurethane resins, epoxy resins, aminoalkyd resins, melamine-urea cocondensed resins, silicone resins, and polysiloxane resins. When the heat curing resin is used, if necessary, for example, curing agents such as crosslinking agents and polymerization initiators, polymerization accelerators, solvents, and viscosity modifiers may be further added.

Antistatic Agent and/or Anti-Dazzling Agent

The hard coat layer according to the present invention preferably comprises an antistatic agent and/or an anti-dazzling agent. The antistatic agent may be the same as described below in connection with the antistatic layer, and the anti-dazzling agent may be the same as described below in connection with the anti-dazzling layer.

Solvent

A composition for a hard coat layer comprising the above components mixed with the solvent is utilized for hard coat layer formation. Specific examples of solvents usable herein include alcohols such as isopropyl alcohol, methanol, and ethanol; ketones such as methyl ethyl ketone, methyl isobutyl ketone, and cyclohexanone; esters such as acetone, methyl acetate, ethyl acetate, and butyl acetate; halogenated hydrocarbons; aromatic hydrocarbons such as toluene and xylene; or mixture thereof. Preferred are ketones.

Antistatic Layer

The antistatic layer comprises an antistatic agent and a resin. The thickness of the antistatic layer is preferably about 30 nm to 1 μm. The mixing weight ratio of the antistatic agent to the resin is not less than 90:10 and not more than 10:90, preferably not less than 75:25 and not more than 50:50.

Antistatic Agent (Electroconductive Agent)

Specific examples of antistatic agents for antistatic layer formation include cationic group-containing various cationic compounds such as quaternary ammonium salts, pyridinium salts, primary, secondary and tertiary amino groups, anionic group-containing anionic compounds such as sulfonic acid bases, sulfuric ester bases, phosphoric ester bases, and phosphonic acid bases, amphoteric compounds such as amino acid and aminosulfuric ester compounds, nonionic compounds such as amino alcohol, glycerin and polyethylene glycol compounds, organometallic compounds such as alkoxides of tin and titanium, and metallic chelate compounds such as their acetylacetonate salts. Further, compounds produced by increasing the molecular weight of the above compounds may also be mentioned. Further, monomers or oligomers, which contain a tertiary amino group, a quaternary ammonium group, or a metallic chelate moiety and are polymerizable upon exposure to ionizing radiations, or polymerizable compounds, for example, organometallic compounds such as coupling agents containing a functional group polymerizable upon exposure to an ionizing radiation may also be used as the antistatic agent. Electroconductive polymers may be mentioned as the antistatic agent, and specific examples thereof include aliphatic conjugated polyacetylenes, aromatic conjugated poly(paraphenylenes), heterocyclic conjugated polypyrroles, polythiophenes, heteroatom-containing conjugated polyanilines, and mixture-type conjugated poly(phenylenevinylenes). Additional examples of electroconductive polymers include double-chain conjugated systems which are conjugated systems having a plurality of conjugated chains in the molecule thereof, and electroconductive composites which are polymers prepared by grafting or block-copolymerizing the above conjugated polymer chain onto a saturated polymer.

Further, electroconductive ultrafine particles may be mentioned as the antistatic agent. Specific examples of electroconductive ultrafine particles include ultrafine particles of metal oxides. Such metal oxides include ZnO (refractive index 1.90; the numerical values within the parentheses being refractive index; the same shall apply herein after), CeO₂ (1.95), Sb₂O₂ (1.71), SnO₂(1.997), indium tin oxide often abbreviated to “ITO” (1.95), In₂O₃ (2.00), Al₂O₃ (1.63), antimony-doped tin oxide (abbreviated to “ATO,” 2.0), and aluminum-doped zinc oxide (abbreviated to “AZO,” 2.0). The term “fine particles” refers to fine particles having a size of not more than 1 micrometer, that is, fine particles of submicron size, preferably fine particles having an average particle diameter of 0.1 nm to 0.1 μm.

Resin

Specific examples of resins usable herein include thermoplastic resins, heat curable resins, ionizing radiation curing resins or ionizing radiation curing compounds (including organic reactive silicon compounds). Thermoplastic resins may also be used as the resin. However, the use of heat curing resins is more preferred. The use of an ionizing radiation curing composition containing an ionizing radiation curing resin or an ionizing radiation curing compound is still more preferred.

The ionizing radiation curing composition may be a mixture prepared by properly mixing prepolymer, oligomer, and/or monomer, having a polymerizable unsaturated bond or an epoxy group in the molecule thereof, together. The ionizing radiation refers to electromagnetic waves or charged particle beams which have energy quantum high enough to polymerize or crosslink the molecule. In general, ultraviolet light or electron beam is used.

Examples of prepolymers and oligomers usable in the ionizing radiation curing composition include: unsaturated polyesters such as condensation products between unsaturated dicarboxylic acids and polyhydric alcohols; methacrylates such as polyester methacrylate, polyether methacrylate, polyol methacrylate, and melamine methacrylate; acrylates such as polyester acrylate, epoxy acrylate, urethane acrylate, polyether acrylate, polyol acrylate, and melamine acrylate; and cationically polymerizable epoxy compounds.

Examples of monomers usable in the ionizing radiation curing composition include: styrenic monomers such as styrene and α-methylstyrene; acrylic esters such as methyl acrylate, 2-ethylhexyl acrylate, methoxyethyl acrylate, butoxyethyl acrylate, butyl acrylate, methoxybutyl acrylate, and phenyl acrylate; methacrylic esters such as methyl methacrylate, ethyl methacrylate, propyl methacrylate, methoxyethyl methacrylate, ethoxymethyl methacrylate, phenyl methacrylate, and lauryl methacrylate; unsaturated substituted-type substituted amino alcohol esters such as 2-(N,N-diethylamino)ethyl acrylate, 2-(N,N-dimethylamino)ethyl acrylate, 2-(N,N-dibenzylamino)methyl acrylate, and 2-(N,N-diethylamino)propyl acrylate; unsaturated carboxylic acid amides such as acrylamide and methacrylamide; compounds such as ethylene glycol diacrylate, propylene glycol diacrylate, neopentyl glycol diacrylate, 1,6-hexanediol diacrylate, and triethylene glycol diacrylate; polyfunctional compounds such as dipropylene glycol diacrylate, ethylene glycol diacrylate, propylene glycol dimethacrylate, and diethylene glycol dimethacrylate; and/or polythiol compounds having two or more thiol groups in the molecule thereof, for example, trimethylolpropane trithioglycolate, trimethylolpropane trithiopropylate, and pentaerythritol tetrathioglycolate.

In general, one of or a mixture of two or more of the above compounds may be used as the monomer in the ionizing radiation curing composition. In this case, from the viewpoint of imparting ordinary suitability for coating to the ionizing radiation curing composition, in the mixture, the content of the prepolymer or oligomer is preferably not less than 5% by weight, and the content of the monomer and/or polythiol compound is not more than 95% by weight.

When flexibility is required of a cured product of a coating of the ionizing radiation curing composition, the amount of the monomer may be reduced, or alternatively, an acrylate monomer with the number of functional groups being one or two may be used. On the other hand, when abrasion resistance, heat resistance, and solvent resistance are required of the cured product of a coating of the ionizing radiation curing composition, the ionizing radiation curing composition may be designed, for example, so that an acrylate monomer having three or more functional groups is used. Monomers having one functional group include 2-hydroxy acrylate, 2-hexyl acrylate, and phenoxyethyl acrylate. Monomers having two functional groups include ethylene glycol diacrylate and 1,6-hexanediol diacrylate. Monomers having three or more functional groups include trimethylolpropane triacrylate, pentaerythritol triacrylate, pentaerythritol tetraacrylate, and dipentaerythritol hexaacrylate.

A polymer resin not curable upon exposure to an ionizing radiation may also be added to the ionizing radiation curing composition in order to regulate properties, for example, the flexibility and surface hardness of the cured product of a coating of the ionizing radiation curing composition. Specific examples of polymer resins usable herein include thermoplastic resins such as polyurethane resins, cellulosic resins, polyvinyl butyral resins, polyester resins, acrylic resins, polyvinyl chloride resins, and polyvinyl acetate resins. Among them, polyurethane resin, cellulosic resin, polyvinyl butyral resin or the like is preferred from the viewpoint of improving the flexibility.

When the ionizing radiation curing composition is cured by ultraviolet irradiation after coating, a photopolymerization initiator or a photopolymerization accelerator may be added. Photopolymerization initiators usable in the case of a resin system having a radically polymerizable unsaturated group include acetophenones, benzophenones, thioxanthones, benzoin, and benzoin methyl ether. They may be used alone or as a mixture of two or more. On the other hand, photopolymerization initiators usable in the case of a resin system having a cationically polymerizable functional group include aromatic diazonium salts, aromatic sulfonium salts, aromatic iodonium salts, metallocene compounds, and benzoinsulfonic esters. They may be used alone or as a mixture of two or more. The amount of the photopolymerization initiator added may be 0.1 to 10 parts by weight based on 100 parts by weight of the ionizing radiation curing composition.

The following organic reactive silicon compounds may be used in combination with the ionizing radiation curing composition.

Organic reactive silicon compounds usable herein include those represented by general formula RₘSi(OR′)ₙ wherein R and R′ each represent an alkyl group having 1 to 10 carbon atoms; and m and n are each an integer with m+n=4.

Specific examples of this type of organic reactive silicon compounds include tetramethoxysilane, tetraethoxysilane, tetra-iso-propoxysilane, tetra-n-propoxysilane, tetra-n-butoxysilane, tetra-sec-butoxysilane, tetra-tert-butoxysilane, tetrapentaethoxysilane, tetrapenta-iso-propoxysilane, tetrapenta-n-propoxysilane, tetrapenta-n-butoxysilane, tetrapenta-sec-butoxysilane, tetrapenta-tert-butoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, methyldimethoxysilane, methyldiethoxysilane, and hexyltrimethoxysilane.

Organosilicon compounds usable in combination with the ionizing radiation curing composition are silane coupling agents. Specific examples of silane coupling agents usable herein include γ-(2-aminoethyl)aminopropyltrimethoxysilane, γ-(2-aminoethyl)aminopropylmethyldimethoxysilane, β-(3,4-epoxycyclohexyl)ethyltrimethoxysilane, γ-aminopropyltriethoxysilane, γ-methacryloxypropylmethoxysilane, N-β-(N-vinylbenzylaminoethyl)-γ-aminopropylmethoxysilane hydrochloride, γ-glycidoxypropyltrimethoxysilane, aminosilane, methylmethoxysilane, vinyltriacetoxysilane, γ-mercaptopropyltrimethoxysilane, γ-chloropropyltrimethoxysilane, hexamethyldisilazane, vinyltris(β-methoxyethoxy)silane, octadecyldimethyl[3-(trimethoxysilyl)propyl]ammonium chloride, methyltrichlorosilane, and dimethyldichlorosilane.

Anti-Dazzling Layer

The anti-dazzling layer comprises an anti-dazzling agent and a resin. The thickness of the anti-dazzling layer is preferably about 1 μm to 10 μm. The solvent and the resin may be the same as described in connection with the hard coat layer.

Anti-Dazzling Agent

Fine particles may be mentioned as the anti-dazzling agent. The fine particles may be, for example, in a truly spherical or elliptical form, preferably in a truly spherical form. The fine particles may be of an inorganic type or an organic type. The fine particles exhibit anti-dazzling properties and are preferably transparent. Specific examples of fine particles include inorganic fine particles, for example, silica beads, and organic fine particles, for example, plastic beads. Specific examples of plastic beads include styrene beads (refractive index 1.60), melamine beads (refractive index 1.57), acrylic beads (refractive index 1.49), acryl-styrene beads (refractive index 1.54), polycarbonate beads, and polyethylene beads. The addition amount of the fine particles is approximately 2 to 30 parts by weight, preferably 10 to 25 parts by weight, based on 100 parts by weight of the transparent resin composition.

In preparing a composition for an anti-dazzling layer, the addition of an anti-settling agent is preferred. The addition of the anti-settling agent can realize the suppression of the settling of the resin beads and can uniform dispersion of the resin beads in the solvent. Specific examples of anti-settling agents include silica beads having a particle diameter of approximately not more than 0.5 μm, preferably 0.1 to 0.25 μm.

The thickness of the anti-dazzling layer (in a cured state) is preferably in the range of 0.1 to 100 μm, more preferably 0.8 to 10 μm. When the layer thickness is in the above-defined range, the function of the anti-dazzling layer can be satisfactorily developed.

Low-Refractive Index Layer

The low-refractive index layer is formed of a resin containing silica or magnesium fluoride, a fluororesin as a low-refractive index resin, or a fluororesin containing silica or magnesium fluoride and may be a thin film having a refractive index of not more than 1.46 and a thickness of approximately 30 nm to 1 μm, or a thin film formed by chemical vapor deposition or physical vapor deposition of silica or magnesium fluoride. The resin other than the fluororesin may be the same as the resin for constituting the antistatic layer.

The low-refractive index layer is more preferably formed of a silicone-containing vinylidene fluoride copolymer. The silicone-containing vinylidene fluoride copolymer is produced by copolymerizing a monomer composition as a starting material comprising 30 to 90% of vinylidene fluoride and 5 to 50% of hexafluoropropylene (the percentage being by mass; the same shall apply hereinafter). Examples of silicone components include (poly)dimethylsiloxane, (poly)diethylsiloxane, (poly)diphenylsiloxane, (poly)methylphenylsiloxane, alkyl-modified (poly)dimethylsiloxane, azo group-containing (poly)dimethylsiloxane, dimethyl silicone, phenylmethyl silicone, alkyl- or aralkyl-modified silicone, fluorosilicone, polyether-modified silicone, fatty acid ester-modified silicone, methyl hydrogen silicone, silanol group-containing silicone, alkoxy group-containing silicone, phenol group-containing silicone, methacryl-modified silicone, amino-modified silicone, carboxylic acid-modified silicone, carbinol-modified silicone, epoxy-modified silicone, mercapto-modified silicone, fluorine-modified silicone, and polyether-modified silicone. Among them, compounds having a dimethylsiloxane structure are preferred.

In the silicone-containing vinylidene fluoride copolymer constituting the low-refractive index layer, the content of vinylidene fluoride in the monomer composition is 30 to 90%, preferably 40 to 80%, particularly preferably 40 to 70%, or the content of hexafluoropropylene in the monomer composition is 5 to 50%, preferably 10 to 50%, particularly preferably 15 to 45%. The monomer composition may further comprise 0 to 40%, preferably 0 to 35%, particularly preferably 10 to 30%, of tetrafluoroethylene.

So far as the purpose and effect of use of the silicone-containing vinylidene fluoride copolymer are not sacrificed, the monomer composition for producing the copolymer may contain other comonomer component(s), for example, in an amount of not more than 20%, preferably not more than 10%. Specific examples of such comonomer components include fluorine atom-containing polymerizable monomers such as fluoroethylene, trifluoroethylene, chlorotrifluoroethylene, 1,2-dichloro-1,2-difluoroethylene, 2-bromo-3,3,3-trifluoroethylene, 3-bromo-3,3-difluoropropylene, 3,3,3-trifluoropropylene, 1,1,2-trichloro-3,3,3-trifluoropropylene, and α-trifluoromethacrylic acid.

The content of fluorine in the fluorine-containing copolymer produced from the monomer composition should be 60 to 70%, preferably 62 to 70%, particularly preferably 64 to 68%. When the fluorine content is in the above-defined range, the fluorine-containing copolymer has good solubility in solvents. The incorporation of the fluorine-containing copolymer as a component can realize the formation of a thin film having excellent adhesion to various base materials, a high level of transparency, a low refractive index, and, at the same time, excellent mechanical strength. Accordingly, very advantageously, mechanical properties such as scratch resistance of the surface on which the thin film has been formed can be rendered satisfactorily high.

The molecular weight of the fluorine-containing copolymer is preferably 5,000 to 200,000, particularly preferably 10,000 to 100,000, in terms of number average molecular weight as determined using polystyrene as a standard. When the fluorine-containing copolymer having this molecular weight is used, the fluororesin composition has suitable viscosity and thus reliably has suitable coatability. Preferably, the fluorine-containing copolymer per se has a refractive index of not more than 1.45, particularly preferably not more than 1.42, still more preferably not more than 1.40. When a fluorine-containing copolymer having a refractive index of more than 1.45 is used, the antireflection effect of the thin film formed using the fluorine-type coating material is sometimes small.

A specific example of a preferred low-refractive index agent is a fluorine-containing compound curable upon exposure to heat or an ionizing radiation. The coefficient of dynamic friction of a cured product of the fluorine-containing compound is preferably 0.02 to 0.18, more preferably 0.03 to 0.15. When the coefficient of dynamic friction is in the above-defined range, the occurrence of scratching upon friction of the surface can be effectively prevented. The contact angle of the cured product with pure water is preferably 90 to 130 degrees, more preferably 100 to 120 degrees. When the contact angle of the cured product with pure water is in the above-defined range, contamination, for example, with fingerprints or oil can be effectively prevented. Fillers such as silica particles may be properly added to the low-refractive index layer according to the present invention from the viewpoint of improving the strength of the film.

Specific examples of curable fluorine-containing compounds used in the low-refractive index agent include perfluoroalkyl group-containing silane compounds (for example, (heptadecafluoro-1,1,2,2-tetrahydrodecyl)triethoxysilane) and, further, fluorine-containing copolymers comprising, as constituents, fluorine-containing monomer units and constitutional units for imparting a crosslinking reactivity.

Specific examples of fluorine-containing monomer units include fluoroolefins (for example, fluoroethylene, vinylidene fluoride, tetrafluoroethylene, hexafluoroethylene, hexafluoropropylene, and perfluoro-2,2-dimethyl-1,3-dioxol), partially or fully fluorinated alkyl ester derivatives of (meth)acrylic acid (for example, Viscoat 6FM (manufactured by Osaka Organic Chemical Industry Ltd.) and M-2020 (manufactured by Daikin Industries, Ltd.)), and fully or partially fluorinated vinyl ethers. Preferred are perfluoroolefins. Hexafluoropropylene is particularly preferred, for example, from the viewpoints of refractive index, solubility, transparency, and availability.

Constitutional units for imparting curing reactivity include constitutional units produced by polymerizing monomers previously containing a self-curable functional group in its molecule such as glycidyl(meth)acrylate and glycidyl vinyl ether, constitutional units produced by polymerizing carboxyl group-, hydroxy group-, amino group-, or sulfo group-containing monomers (for example, (meth)acrylic acid, methylol (meth)acrylate, hydroxyalkyl(meth)acrylate, allyl acrylate, hydroxyethyl vinyl ether, hydroxybutyl vinyl ether, maleic acid, or crotonic acid), and constitutional units containing a curing reactive group, such as a (meth)acryloyl group, introduced, for example, by a polymer reaction (for example, the curing reactive group may be introduced, for example, by allowing acrylic acid chloride to act on a hydroxy group) into the constitutional unit.

In addition to the above fluorine-containing monomer unit and the constitutional unit for imparting curing reactivity, a fluorine atom-free monomer may be properly copolymerized, for example, from the viewpoints of solubility in solvents and transparency of the film. The monomer unit usable in combination is not particularly limited, and examples thereof include olefins (for example, ethylene, propylene, isoprene, vinyl chloride, or vinylidene chloride), acrylic esters (for example, methyl acrylate, methyl acrylate, ethyl acrylate, or 2-ethylhexyl acrylate), methacrylic esters (for example, methyl methacrylate, ethyl methacrylate, butyl methacrylate, or ethylene glycol dimethacrylate), styrene derivatives (for example, styrene, divinyl benzene, vinyltoluene, or α-methylstyrene), vinyl ethers (for example, methylvinyl ether, ethylvinyl ether, or cyclohexyl vinyl ether), vinyl esters (for example, vinyl acetate, vinyl propionate, or vinyl cinnamate), acrylamides (for example, N-tert butylacrylamide or N-cyclohexylacrylamide), methacrylamides, and acrylonitrile derivatives.

As described in Japanese Patent Laid-Open No. 92323/1996, Japanese Patent Laid-Open No. 25388/1998, Japanese Patent Laid-Open No. 147739/1998, and Japanese Patent Laid-Open No. 17028/2000, the polymer may be properly used in combination with a curing agent. In particular, when the curing reactive group of the polymer is a group which as such does not have any curing reactivity, such as a hydroxyl or carboxyl group, the use of the curing agent is indispensable. Curing agents include, for example, polyisocyanate, aminoplasts, polybasic acids, or anhydrides thereof. On the other hand, when the curing reactive group is a self-curing reactive group, there is no need to add any curing agent. If necessary, however, various curing agents such as polyfunctional (meth)acrylate compounds and polyfunctional epoxy compounds may also be further used.

A fluorine-containing copolymers particularly useful as the low-refractive index agent is a random copolymer of perfluoroolefins with vinyl ethers or vinyl esters. In particular, the fluorine-containing copolymer preferably contains a group which as such can undergo a crosslinking reaction [for example, a radically reactive group such as an (meth)acryloyl group, an epoxy group, an oxetanyl group or other ring opening polymerizable group]. Preferably not less than 5% by mole and not more than 70% by mole, particularly preferably not less than 30% by mole and not more than 60% by mole, of all the polymerization units of the polymer is accounted for by the crosslinking reactive group-containing polymerization unit.

Further, in the low-refractive index agent according to the present invention, a polysiloxane structure is preferably introduced into the fluorine-containing polymer from the viewpoint of imparting the contamination preventive property. The polysiloxane structure can be introduced by any method without particular limitation. Preferred methods thereof include, for example, methods as described in Japanese Patent Laid-Open No. 189621/1999, Japanese Patent Laid-Open No. 228631/1999, Japanese Patent Laid-Open No. 313709/2000, in which a polysiloxane block comonomer component is introduced using a silicone macroazo initiator, and a method as described in Japanese Patent Laid-Open No. 251555/1990 and Japanese Patent Laid-Open No. 308806/1990, in which a polysiloxane graft comonomer component is introduced using a silicone macromer. In these cases, the content of the polysiloxane component in the polymer is preferably not less than 0.5% by mass and not more than 10% by mass, particularly preferably not less than 1% by mass and not more than 5% by mass.

In order to impart contamination preventive properties, in addition to the above methods, a method is also preferred in which reactive group-containing polysiloxane (for example, tradenames; KF-100T, X-22-169AS, KF-102, X-22-3701IE, X-22-164B, X-22-5002, X-22-173B, X-22-174D, X-22-167B, and X-22-161AS, the above products being manufactured by The Shin-Etsu Chemical Co., Ltd., tradenames; AK-5, AK-30, and AK-32, the above products being manufactured by TOAGOSEI Co., Ltd., and tradenames; SILAPLANE FM0275 and SILAPLANE FM0721, the above products being manufactured by Chisso Corp.) are added. In this case, the addition amount of the polysiloxane is preferably not less than 0.5% by mass and not more than 10% by mass, particularly preferably not less than 1% by mass and not more than 5% by mass, based on the total solid content of the low-refractive index layer.

In the low-refractive index agent according to the present invention, for example, TEFRON(R): AF1600 (manufactured by Du Pont (E.I.) de Nemours & Co.: refractive index n=1.30), CYTOP (manufactured by Asahi Glass Co., Ltd.: n=1.34), 17FM (manufactured by Mitsubishi Rayon Co., Ltd.: n=1.35), Opstar JN-7212 (manufactured by JSR Corporation: n=1.40), Opstar JN-7228 (manufactured by JSR Corporation: n=1.42), and LR201 (manufactured by Nissan Chemical Industries Ltd.: n=1.38) (all the above products being tradenames) are also usable as commercially available fluorine-containing compounds.

In addition, the low-refractive index layer may be a thin film of SiO₂ formed, for example, by a vapor deposition method, a sputtering method or a plasma CDV method, or a method in which an SiO₂ gel film is formed from a sol liquid containing an SiO₂ sol. The low-refractive index layer may be, in addition to the thin film of SiO₂, a thin film of MgF₂ or a thin film of other material. However, the use of a thin film of SiO₂ is preferred because the adhesion to the lower layer is high. Among the above methods, when a plasma CVD method is used, preferably, the thin film is formed by using an organosiloxane as a starting gas under such conditions that any other inorganic material vapor deposition source is absent. Further, the vapor deposition is preferably carried out in such a state that the object on which the material is to be deposited is maintained at the lowest possible temperature.

In a preferred embodiment of the present invention, the utilization of “void-containing fine particles” as a low-refractive index agent is preferred. “Void-containing fine particles” can lower the refractive index while maintaining the layer strength of the low-refractive index layer. In the present invention, the term “void-containing fine particle” refers to a fine particle which has a structure comprising air filled into the inside of the fine particle and/or an air-containing porous structure and has such a property that the refractive index is lowered in reverse proportion to the proportion of air which occupies the fine particle as compared with the refractive index of the original fine particle. Further, such a fine particle which can form a nanoporous structure in at least a part of the inside and/or surface of the coating film by utilizing the form, structure, aggregated state, and dispersed state of the fine particle within the coating film, is also embraced in the present invention.

Specific examples of preferred void-containing inorganic fine particles are silica fine particles prepared by a technique disclosed in Japanese Patent Laid-Open No. 233611/2001. The void-containing silica fine particles can easily be produced. Further, the hardness of the void-containing fine particles is high. Therefore, when a low-refractive index layer is formed by using a mixture of the void-containing silica fine particles with a binder, the layer has improved strength and, at the same time, the refractive index can be regulated to a range of approximately 1.20 to 1.45. In particular, hollow polymer fine particles produced by using a technique disclosed in Japanese Patent Laid-Open No. 80503/2002 may be mentioned as a specific example of preferred void-containing organic fine particles.

Fine particles which can form a nanoporous structure in at least a part of the inside and/or surface of the coating film include, in addition to the above silica fine particles, sustained release materials, which have been produced for increasing the specific surface area and adsorb various chemical substances on a packing column and the porous part of the surface, porous fine particles used for catalyst fixation purposes, or dispersions or aggregates of hollow fine particles to be incorporated in heat insulating materials or low-dielectric materials. Specific examples of such fine particles include commercially available products, for example, aggregates of porous silica fine particles selected from tradename Nipsil and tradename Nipgel manufactured by Nippon Silica Industrial Co., Ltd. and colloidal silica UP series (tradename), manufactured by Nissan Chemical Industries Ltd., having such a structure that silica fine particles have been connected to one another in a chain form, and fine particles in a preferred particle diameter range specified in the present invention may be selected from the above fine particles.

The average particle diameter of the fine particles is not less than 5 nm and not more than 300 nm. Preferably, the lower limit of the average particle diameter is 8 nm, and the upper limit of the average particle diameter is 100 nm. More preferably, the lower limit of the average particle diameter is 10 nm, and the upper limit of the average particle diameter is 80 nm. When the average diameter of the fine particles is in the above-defined range, excellent transparency can be imparted to the low-refractive index layer.

Formation of Low-Refractive Index Layer

A coating film may be formed by exposing the fluorine-containing copolymer and the resin to an actinic radiation if necessary in the presence of a photopolymerization initiator for polymerization or by heating the fluorine-containing copolymer and the resin in the presence of a thermal polymerization initiator for polymerization. The resin used may be the same as that described above in connection with the anti-dazzling layer.

The addition amount of the resin is 30 to 150 parts by weight, preferably 35 to 100 parts by weight, particularly preferably 40 to 70 parts by weight, based on 100 parts by weight of the fluorine-containing copolymer. The content of fluorine based on the total amount of the polymer forming component comprising the fluorine-containing copolymer and the resin is 30 to 55% by weight, preferably 35 to 50% by weight.

When the addition amount or the fluorine content is in the above-defined range, the low-refractive index layer has good adhesion to the base material and has a low refractive index, whereby good antireflection effect can be attained.

In forming the low-refractive index layer, preferably, a proper solvent is if necessary used to prepare a resin composition having a viscosity in the range of 0.5 to 5 cps (25° C.), more preferably 0.7 to 3 cps (25° C.), which can provide good coatability. This can realize an antireflection film, which can prevent the reflection of visible light well, and the formation of an even and uniform thin coating film, and, at the same time, can form a low-refractive index layer having particularly excellent adhesion to the base material.

The resin can be cured in the same manner as described above in connection with the anti-dazzling layer. When heating means is utilized for curing treatment, preferably, a thermal polymerization initiator which, upon heating, generates, for example, radicals to initiate the polymerization of the polymerizable compound, is added to the fluororesin composition.

The film thickness (nm) d_{A} of the low-refractive index layer preferably satisfies formula (V):

d_{A}=mλ/(4n_{A}) (V)

wherein

n_{A} represents the refractive index of the low-refractive index layer;

m represents a positive odd number, preferably 1;

λ represents a wavelength, preferably a wavelength value in the range of 480 to 580 nm.

Further, in the present invention, from the viewpoint of lowering reflectance, the low-refractive index layer preferably satisfies numerical formula (VI):

120<n_{A}d_{A}<145 (VI)

Contamination Preventive Layer

In a preferred embodiment of the present invention, a contamination preventive layer may be provided to prevent the contamination of the outermost surface of the low-refractive index layer. Preferably, a contamination preventive layer is provided on the light transparent base material on its side remote from the low-refractive index layer. The contamination preventive layer can further improve the contamination preventive property and scratch resistance of the antireflection laminate.

Specific examples of agents for the contamination preventive layer include fluorine-type compounds and/or silicon-type compounds, which have low compatibility with an ionizing radiation curing resin composition having a fluorine atom in its molecule and have hitherto been regarded as difficult to be added to the low-refractive index layer, and fluorine-type compounds and/or silicon-type compounds compatible with ionizing radiation curing resin compositions containing a fluorine atom in the molecule thereof and fine particles.

2. Display Element

Display elements include liquid crystal displays, EL displays, plasma displays, light emitting diode displays, and fluorescent displays. Preferred are liquid crystal displays and EL displays. They may be conventional ones.

3. Image Display Member

In another embodiment of the present invention, there is provided an image display member utilizing a polarizing plate according to the present invention. Specifically, the image display member comprises a display element held between first and second polarizing plates, wherein

the first polarizing plate is the above-described polarizing plate according to the present invention and is located on a viewer side, and

the second polarizing plate comprises two light transparent base materials and a polarizer held between the two light transparent base materials.

In a preferred embodiment of the present invention, one of the light transparent base materials in the second polarizing plate is a nonstretched base material, and the other light transparent base material in the second polarizing plate is a nonstretched base material or a stretched base material. More preferably, the stretched base material is polyethylene terephthalate, and the nonstretched base material is triacetate cellulose.

4. Image Display Device

In the present invention, there is provided an image display device comprising a polarizing plate or an image display member. The image display device according to the present invention may be used displays such as televisions, computers, and word processors. Among others, the image display device according to the present invention is used in the surface of displays such as CRTs (cathode ray tube displays), PDPs (plasma displays), LCDs (liquid crystal panel displays), and ELDs (electroluminescent displays).

### EXAMPLES

The following Examples further illustrate the present invention. However, it should be noted that the contents of the present invention are not limited by these Examples.

Production of Polarizer

A polyvinyl alcohol film having a thickness of 75 μm, a degree of polymerization of 2400, and a degree of saponification of not less than 99.9% was monoaxially stretched by a dry process at a stretch ratio of 5 times and, while maintaining the state of tension, was immersed for 60 sec in an aqueous solution containing, based on 100 parts by weight of water, 0.03 part by weight of iodine and 5 parts by weight of potassium iodide and having a temperature of 28° C. Next, while maintaining the state of tension, the film was immersed for 300 sec in an aqueous boric acid solution containing, based on 100 parts by weight of water, 8.0 parts by weight of boric acid and 6.8 parts by weight of potassium iodide and having a temperature of 71° C. Thereafter, the film was washed with pure water of 28° C. for 10 sec. The water-washed film was dried at 50° C. for 600 sec to produce a polarizer.

Production of Composition for Interface Preventive Adhesive Layer

Composition 1 for Interface Preventive Adhesive Layer

The following resin and dispersion liquid were mixed at a ratio of 88:12 to prepare composition 1 for an interface preventive adhesive layer.

Composition of Resin

Resin: Vylon 280 (manufactured by Toyobo Co., Ltd.)

Solvent: toluene and methyl ethyl ketone:methyl ethyl ketone (1:1)

| Composition of dispersion liquid | |
|---|---|
| Rutile-type titanium dioxide: MT-500HD | 10 |
| (manufactured by Tayca Corporation) | |
| pts. wt. | |
| Dispersant: DISPERBYK-163 | 2 |
| (manufactured by BYK-Chemie Japan KK) | |
| pts. wt. | |
| Photo curing resin: PET30 | 4 |
| (manufactured by Nippon Kayaku Co., Ltd.) | |
| pts. wt. | |
| Titanate coupling agent: TA-25 | 1.28 |
| (manufactured by Matsumoto Trading Co., Ltd.) | |
| pts. wt. | |
| Photo initiator: Irgacure 184 | 0.2 |
| (manufactured by CIBA-GEIGY (Japan) Ltd.) | |
| pt. wt. | |
| Methyl isobutyl ketone | 17.48 |
| pts. wt. | |

Composition 2 for Interface Preventive Adhesive Layer

Composition 2 for an interface preventive adhesive layer was prepared in the same manner as in composition 1 for an interface preventive adhesive layer, except that, in the composition of the resin, LX660 and KW75 (4:3) (manufactured by Dainippon Ink and Chemicals, Inc.) as a two component-type heat curable urethane adhesive were used instead of Vylon 280 (manufactured by Toyobo Co., Ltd.), and the mixing ratio between the resin and the dispersion liquid was changed to 84:16.

Composition 3 for Interface Preventive Adhesive Layer

Composition 3 for an interface preventive adhesive layer was prepared in the same manner as in composition 1 for an interface preventive adhesive layer, except that, in the composition of the resin, LX660 and KW75 (manufactured by Dainippon Ink and Chemicals, Inc.) as a two component-type heat curable urethane adhesive and Vylon 300 as a polyether resin (manufactured by Toyobo Co., Ltd.) (10:1:1) were used instead of Vylon 280 (manufactured by Toyobo Co., Ltd.) and the mixing ratio between the resin and the dispersion liquid was changed to 75:25.

Composition 4 for Interface Preventive Adhesive Layer

Composition 4 for an interface preventive adhesive layer was prepared in the same manner as in composition 1 for an interface preventive adhesive layer, except that the composition ratio of the resin to the dispersion liquid in composition 1 for an interface preventive adhesive layer was changed to 68:32.

Composition 5 for Interface Preventive Adhesive Layer

Composition 5 for an interface preventive adhesive layer was prepared in the same manner as in composition 1 for an interface preventive adhesive layer, except that the composition ratio of the resin to the dispersion liquid in composition 1 for an interface preventive adhesive layer was changed to 95:5.

Production of Composition for Hard Coat Layer

A resin for a hard coat prepared by mixing DPHA, an acrylic polymer, and Irgacure 184 at a mixing ratio of 80:20:6 was diluted with toluene to prepare a composition for a hard coat layer.

Production of Adhesive

Adhesive 1

A 5 wt % aqueous polyvinyl alcohol solution

Adhesive 2

A 20 wt % aqueous isocyanate resin solution (manufactured by MITSUI TAKEDA CHEMICALS, INC.: TakenateWD-725)

Production of Polarizing Plate

### Example 1

1) An 80 μm-thick triacetylcellulose (TAC) film (nonstretched base material: first light transparent base material) having a surface subjected to saponification treatment, in which the film was immersed in a 2 mol/liter NaOH (or KOH) solution: 55° C. for 3 min, was washed with water, was subjected to complete removal of water droplets with Kimwipes and was then dried for one min in an oven of 50° C., was provided. Adhesive 1 was coated on the film to a thickness of 100 nm on a dry basis. The coated film was applied to a regulated polarizer. The assembly was dried at 60° C. for 5 min to remove the solvent, whereby a TAC protective film was stacked on one side of the polarizer.

2) A 100 μm-thick polyethylene terephthalate (PET) film (A4100, manufactured by Toyobo Co., Ltd.) (stretched base material: second light transparent base material) one side of which has been subjected to easy adhesion treatment was provided. Composition 1 for an interface preventive adhesive layer was gravure coated on the film in its surface not subjected to easy adhesion treatment to a thickness of 100 nm, and the coated film was dried at 70° C. for one min. Thereafter, a composition for a hard coat layer was gravure coated onto the interface preventive adhesive layer to a thickness of 6 μm, and the assembly was then dried at 70° C. for one min, followed by UV irradiation at 136 mj to cure the coating. Thus, an optical laminate was produced.

3) Adhesive 2 was coated onto the PTE (stretched base material: second light transparent base material), in the optical laminate, on its easy adhesion treated surface to a thickness of 100 nm on a dry basis. The assembly was applied to the polarizer, with a TAC film applied thereon, on its TAC-free face, then was dried at 60° C. for 5 min, and was aged at 40° C. for 72 hr to produce a polarizing plate. The interface preventive adhesive layer had a refractive index of 1.57, and interference fringes did not occur.

### Example 2

A polarizing plate was produced in the same manner as in Example 1, except that composition 2 for an interface preventive adhesive layer was used instead of composition 1 for an interface preventive adhesive layer, the coverage of the composition 2 for an interface preventive adhesive layer on a dry basis was changed to a thickness of 50 nm, and the assembly was aged at 40° C. for 96 hr. The interface preventive adhesive layer had a refractive index of 1.58, and interference fringes did not occur.

### Example 3

A polarizing plate was produced in the same manner as in Example 1, except that composition 3 for an interface preventive adhesive layer was used instead of composition 1 for an interface preventive adhesive layer, the coverage of the composition 3 for an interface preventive adhesive layer on a dry basis was changed to a thickness of 150 nm, and the assembly was aged at 40° C. for 96 hr. The interface preventive adhesive layer had a refractive index of 1.59, and interference fringes did not occur.

### Comparative Example 1

A polarizing plate was produced in the same manner as in Example 1, except that a commercially available PET film (100 μm: A4300 [manufactured by Toyobo Co., Ltd.]) both sides of which had been subjected to easy adhesion treatment (refractive index of 1.56) was used instead of the PET film (stretched base material: second light transparent base material) and interface preventive adhesive layer 1 was not used. An interface occurred between the PET film and the hard coat layer, and strong interference fringes occurred.

### Comparative Example 2

A polarizing plate was produced in the same manner as in Example 1, except that composition 4 for an interface preventive adhesive layer was used instead of composition 1 for an interface preventive adhesive layer. The interface preventive adhesive layer had a refractive index of 1.65, and interference fringes occurred. Further, due to the high inorganic ultra fine particle content, no satisfactory adhesion could be provided.

### Comparative Example 3

A polarizing plate was produced in the same manner as in Example 1, except that composition 5 for an interface preventive adhesive layer was used instead of composition 1 for an interface preventive adhesive layer. The interface preventive adhesive layer had a refractive index of 1.54, and interference fringes occurred.

### Comparative Example 4

1) An 80 μm-thick triacetylcellulose (TAC) film (nonstretched base material: first light transparent base material) having a surface subjected to saponification treatment, in which the film was immersed in a 2 mol/liter NaOH (or KOH) solution: 55° C. for 3 min, was washed with water, was subjected to complete removal of water droplets with Kimwipes and was then dried for one min in an oven of 50° C., was provided. Adhesive 1 was coated on the film to a thickness of 100 nm on a dry basis. The coated film was applied to a regulated polarizer. The assembly was dried at 60° C. for 5 min to remove the solvent, whereby a TAC protective film was stacked on one side of the polarizer.

2) An 80 μm-thick triacetylcellulose (TAC) film (nonstretched base material: second light transparent base material) was provided. A composition for a hard coat layer was gravure coated on the film to a thickness of 6 μm. The coated film was dried at 70° C. for one min followed by UV irradiation at 136 mj for curing to produce an optical laminate.

3) This optical laminate was saponified. Adhesive 1 was coated onto the optical laminate in its side remote from the hard coat to a thickness of 100 nm on a dry basis, followed by lamination. The assembly was dried at 60° C. for 5 min to remove the solvent and was then aged at 40° C. for 72 hr to produce a polarizing plate. Since the interface preventive adhesive layer was not provided, interference fringes occurred. Further, since the second light transparent base material was of a nonstretched type, the flatness of the surface was lowered and the hardness was poor.

Evaluation Test

The following evaluation tests were carried out for optical laminates of Examples and Comparative Examples. The results were shown in Table 1

Evaluation 1: Strength (Hardness)

A pencil hardness was adopted as the hardness of the optical laminate. The pencil hardness was measured according to JIS K 5400 and was evaluated according to the following criteria.

Evaluation Criteria

⊚: Strength of 3H or more

x: Strength of less than H

Evaluation 2: Adhesion

The outermost surface of the optical laminate was visually inspected for the separation of the coating film according to JIS K 5400 (cross-cut adhesion test method), and the results were evaluated according to the following criteria.

Evaluation Criteria

⊚: Coating film was not separated at all.

◯: Coating film was partly separated.

x: Coating film was entirely separated.

Evaluation 3: Interference Fringes

In order to prevent the backside reflection of the optical laminate, a black tape was applied the side remote from the hard coat layer in the optical laminate, and, in this state, the optical laminate was visually observed from the face of the hard coat layer under three-wavelength fluorescence, and the results were evaluated according to the following criteria.

Evaluation Criteria

⊚: The occurrence of interference fringes was not found by visual observation in all directions.

◯: The occurrence of interference fringes was somewhat found by visual observation in all directions but not on a level that poses a problem of a product.

x: The occurrence of interference fringes was found by visual observation in all directions.

Evaluation 4: Surface Flatness

A black acrylic plate having a thickness of not less than 1 mm was applied onto the optical laminate in its side remote from the hard coat face using a transparent pressure-sensitive adhesive sheet (for example, TD-06A, manufactured by Tomoegawa Paper Co., Ltd.), and the sample was placed on a horizontal desk. The reflection of a light image of a white fluorescent lamp tube (32 W×2) provided 2.5 m above the desk, from the hard coat face was visually inspected, and the results were evaluated according to the following criteria.

Evaluation Criteria

⊚: A line of a reflected light image of the fluorescent lamp tube was not distorted and was seen straightly, and the flatness was good.

x: A line of a reflected light image of the fluorescent lamp tube was distorted, and the flatness was poor.

Evaluation 5: Moisture Resistance: Moisture Permeability

The moisture permeability of the second light transparent base material used in Examples and Comparative Examples was measured according to JIS Z 0208. The moisture permeability referred to herein is a measured value for the film base material having the actually adopted film thickness. As a result, the TAC film used as a nonstretched base material had a low moisture resistance of 470 g/m²/24 hr, whereas the PET film used as a stretched base material had an excellent moisture resistance of 7 to 19 g/m²/24 hr.

TABLE 1

| | Composition for | | | | |
|---|---|---|---|---|---|
| | interface preventive | | | | |
| | adhesive layer | Evalua- | Evalua- | Evalua- | Evalua- |
| | Resin:dispersion | tion | tion | tion | tion |
| | liquid | 1 | 2 | 3 | 4 |
| Ex. 1 | 88:12 | ⊚ | ⊚ | ⊚ | ⊚ |
| Ex. 2 | 84:16 | ⊚ | ⊚ | ⊚ | ⊚ |
| Ex. 3 | 75:25 | ⊚ | ⊚ | ⊚ | ⊚ |
| Comp. | — | x | ⊚ | x | ⊚ |
| Ex. 1 | | | | | |
| Comp. | 68:32 | ⊚ | x | x | ⊚ |
| Ex. 2 | | | | | |
| Comp. | 95:5 | ⊚ | ⊚ | x | ⊚ |
| Ex. 3 | | | | | |
| Comp. | — | x | ⊚ | x | x |
| Ex. 4 | | | | | |

1. A polarizing plate comprising a first light transparent base material, a polarizer and an optical laminate in that order provided on the first light transparent base material, wherein
the first light transparent base material is a nonstretched base material,
the optical laminate comprises a second light transparent base material which is a stretched base material,
the optical laminate comprises one or at least two optical property layers provided on the second light transparent base material, and
the interface of the second light transparent base material and the optical property layer has been rendered absent by providing the optical property layer on the second light transparent base material through an interface preventive adhesive layer.

2. The polarizing plate according to claim 1, wherein the stretched base material is a monoaxially stretched base material or a biaxially stretched base material.

3. The polarizing plate according to claim 1, wherein the stretched base material is formed of polyethylene terephthalate.

4. The polarizing plate according to claim 1, wherein the nonstretched base material is triacetate cellulose.

5. The polarizing plate according to claim 1, wherein
the interface preventive adhesive layer has been formed using a resin and a dispersion liquid, and
the dispersion liquid comprises metal oxide fine particles having a primary particle diameter of not less than 1 nm and not more than 30 nm, an ionizing radiation curing resin, an anionic polar group-containing dispersing agent, an organic solvent, and a titanate-type or aluminum-type coupling agent.

6. The polarizing plate according to claim 5, wherein the metal oxide fine particles are fine particles of one material or a mixture of two or more materials selected from the group consisting of titanium oxide, zirconium oxide, zinc oxide, tin oxide, cerium oxide, antimony oxide, indium tin mixed oxide, and antimony tin mixed oxide.

7. The polarizing plate according to claim 5, wherein the mixing ratio between the resin and the dispersion liquid is not less than 75:25 and not more than 92:8.

8. The polarizing plate according to claim 5, wherein the resin is a polyester resin or a urethane resin.

9. The polarizing plate according to claim 5, wherein the interface preventive adhesive layer further comprises an isocyanate group-containing compound.

10. The polarizing plate according to claim 1, wherein the optical properly layer is one or at least two layers selected from the group consisting of a hard coat layer, an antistatic layer, an anti-dazzling layer, a low-refractive index layer, and a contamination preventive layer.

11. An image display member comprising a display element held between a first polarizing plate and a second polarizing plate, wherein
the first polarizing plate is one according to claim 1, and is located on a viewer side, and
the second polarizing plate comprises two light transparent base material and a polarizer held between the light transparent base materials.

12. The image display member according to claim 11, wherein one of the light transparent base materials constituting second polarizing plate is a nonstretched base material, and the other light transparent base material in the second polarizing plate is a nonstretched base material or a stretched base material.

13. The image display member according to claim 11, wherein the stretched base material is polyethylene terephthalate.

14. The image display member according to claim 11, wherein the nonstretched base material is triacetate cellulose.

15. An image display device comprising a polarizing plate according to claim 1.

16. An image display device comprising an image display member according to claim 11.
